(19) United States
(12) Patent Application Publication
(10) Pub. No.: US 2018/0175568 A1
(43) Pub. Date: Jun. 21, 2018

(54) USB-C PLUG RECEPTACLE

(71) Applicant: Microsoft Technology Licensing, LLC, Redmond, WA (US)

(72) Inventor: Ivan A. McCracken, Bellevue, WA (US)

(21) Appl. No.: 15/490,547

(22) Filed: Apr. 18, 2017

Related U.S. Application Data
(60) Provisional application No. 62/435,457, filed on Dec. 16, 2016.

(51) Int. Cl. H01R 24/64; H01R 13/516; H01R 13/50; H01R 13/10

(52) U.S. Cl. CPC H01R 24/64; H01R 13/516; H01R 2107/00; H01R 13/10; H01R 13/50

(57) ABSTRACT

A USB-C receptacle includes a housing and a tongue assembly. The housing includes first and second sidewalls and may include first and second support members. The housing may be directly attached to the chassis of a computing device and may secure a USB-C plug. The tongue assembly includes a mid-plate. The tongue assembly and mid-plate may reside between the first and second sidewalls of the housing.

### CROSS-REFERENCE TO RELATED APPLICATIONS

This application claims the benefit of U.S. Provisional Patent Application No. 62/435,457, filed on Dec. 16, 2016, which is hereby incorporated by reference in its entirety.

### BACKGROUND

### Background and Relevant Art

Use of computing devices is becoming more ubiquitous by the day. Computing devices range from standard desktop computers to wearable computing technology and beyond. Computing devices include various types of communication devices that can be used to connect a computing device with other computing devices and/or accessories.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

In one embodiment, a USB-C receptacle housing is described. The USB-C receptacle housing includes a first housing sidewall configured to be attached to a chassis of a computing device and a second housing sidewall configured to be attached to the chassis of the computing device. The first and second housing sidewalls have a height equal to or less than about 2.85 mm.

In another embodiment, a USB-C receptacle tongue having a mid-plate is described. The mid-plate includes a central portion and first and second mid-plate sidewalls configured to receive a plug retention latch. A height of the first and second mid-plate sidewalls is greater than a height of the central portion of the mid-plate.

In a further embodiment, a system for receiving a USB-C plug is described. The system includes a receptacle housing. The receptacle housing includes a first housing sidewall configured to be attached to a chassis of a computing device and a second housing sidewall configured to be attached to the chassis of the computing device. The first and second housing sidewalls have a height equal to or less than about 2.85 mm. The receptacle housing includes a receptacle tongue with a mid-plate. The mid-plate includes a central portion and first and second mid-plate sidewalls configured to receive a plug retention latch. A height of the first and second mid-plate sidewalls is greater than a height of the central portion of the mid-plate.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims, or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1-1 is a perspective view of an embodiment of a USB-C receptacle;

FIG. 1-2 is an exploded view of the embodiment of FIG. 1-1;

FIG. 2-1 is a perspective view of an embodiment of a USB-C receptacle housing;

FIG. 2-2 is a front view of the embodiment of FIG. 2-1;

FIG. 3-1 is a perspective view of a USB-C plug being inserted into an embodiment of a USB-C receptacle housing;

FIG. 3-2 is a front view of the embodiment illustrated in FIG. 3-1;

FIG. 4-1 is a perspective view of an embodiment of a USB-C receptacle housing;

FIG. 4-2 is a top view of the embodiment of FIG. 4-1;

FIG. 4-3 is a front view of the embodiment of FIG. 4-1;

FIG. 5-1 is a perspective view of an embodiment of a USB-C receptacle tongue assembly;

FIG. 5-2 is an exploded view of the embodiment of FIG. 5-1;

FIG. 6-1 is a perspective view of an embodiment of a mid-plate of a tongue assembly;

FIG. 6-2 is a front view the embodiment of FIG. 6-1;

FIG. 6-3 is a cross-sectional view of an embodiment of a tongue assembly, illustrating the embodiment of the mid-plate of FIG. 6-1.

FIG. 6-4 is a flowchart describing the steps of a mid-plate manufacturing process;

FIG. 7-1 is a top view of an embodiment of a mid-plate of a tongue assembly;

FIG. 7-2 is a top view of the embodiment of FIG. 7-1 including an embodiment of a tongue assembly;

FIG. 8-1 is a top view of a USB-C receptacle and a plug being inserted therein;

FIG. 8-2 is a top view of the embodiment of FIG. 8-1 and a plug fully inserted therein;

FIG. 9 is a top view of a USB-C receptacle and plug inserted therein;

FIGS. 10 through 12 are perspective views of various embodiments of USB-C receptacles attached to a chassis of a computing device;

FIG. 13-1 is a perspective view of a USB-C receptacle fully integrated into a computing device;

FIG. 13-2 is a zoomed in view of the embodiment of FIG. 13-1; and

FIG. 13-3 is a perspective view of a USB-C receptacle fully integrated into a computing device.

### DETAILED DESCRIPTION

This disclosure generally relates to data connectors, systems, and methods of use and manufacturing. More particularly, this disclosure generally relates to USB-C connection, systems, and methods of use and manufacturing.

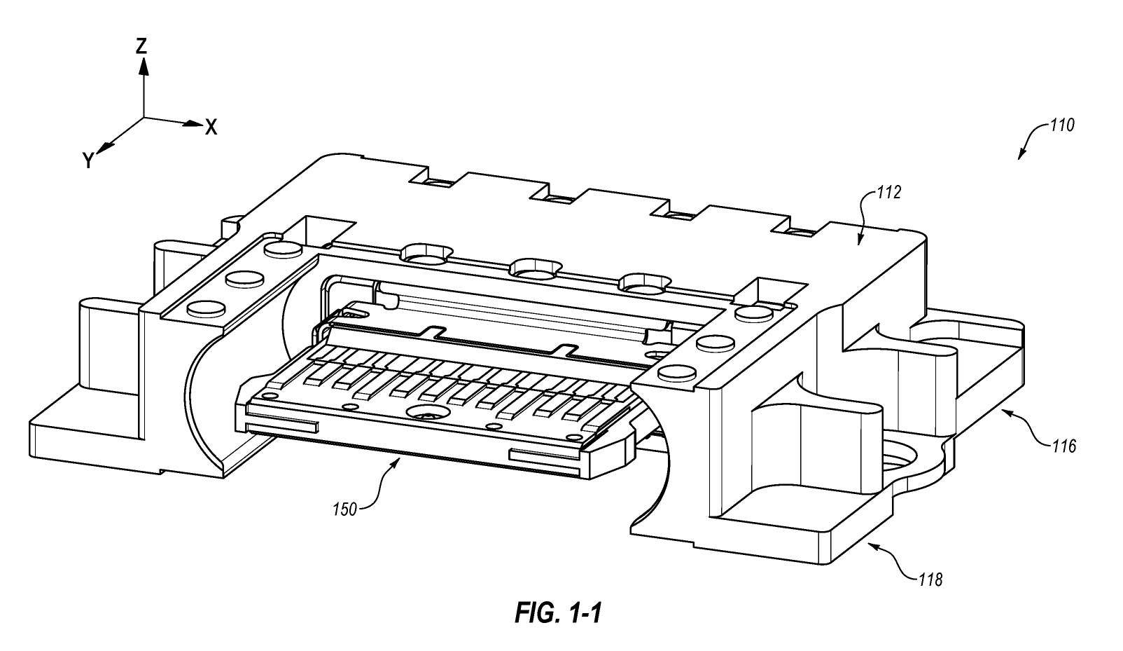

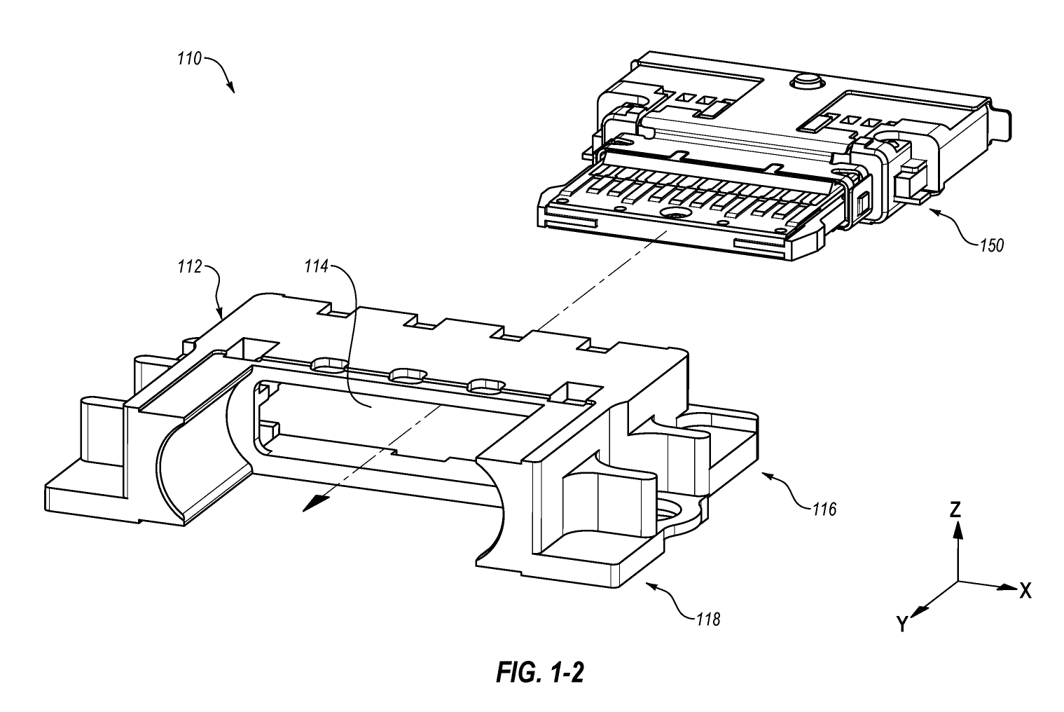

A USB-C connection may include a USB-C receptacle 110. As illustrated in FIG. 1-1, one or more embodiments of a USB-C receptacle 110 may include a receptacle housing 112 and a tongue assembly 150. The USB-C receptacle 110 is sized and configured to receive a USB-C plug. For example, one or more embodiments described herein may meet the requirements of the USB-C specification.

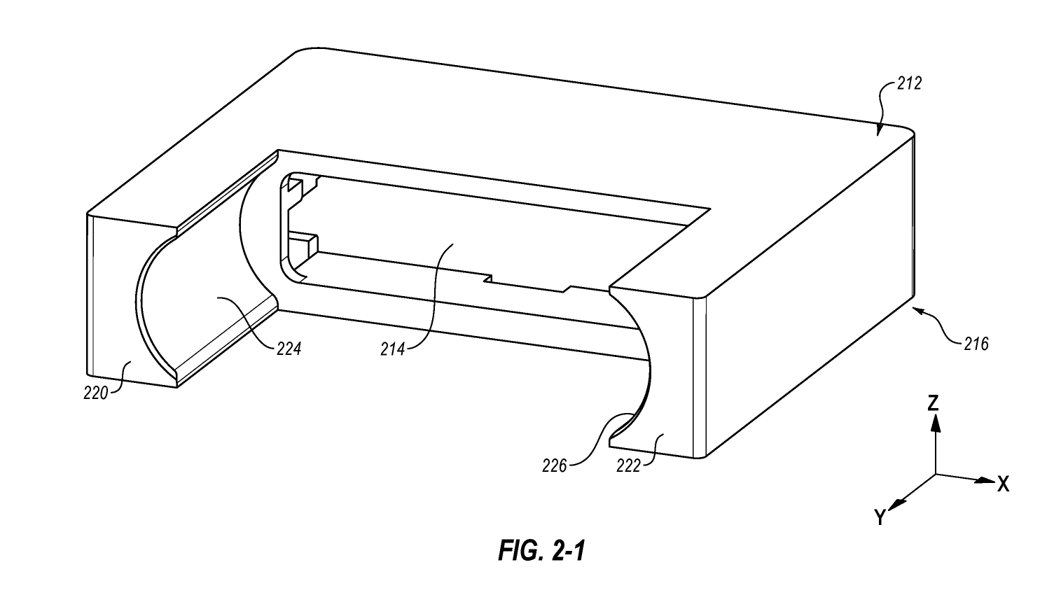

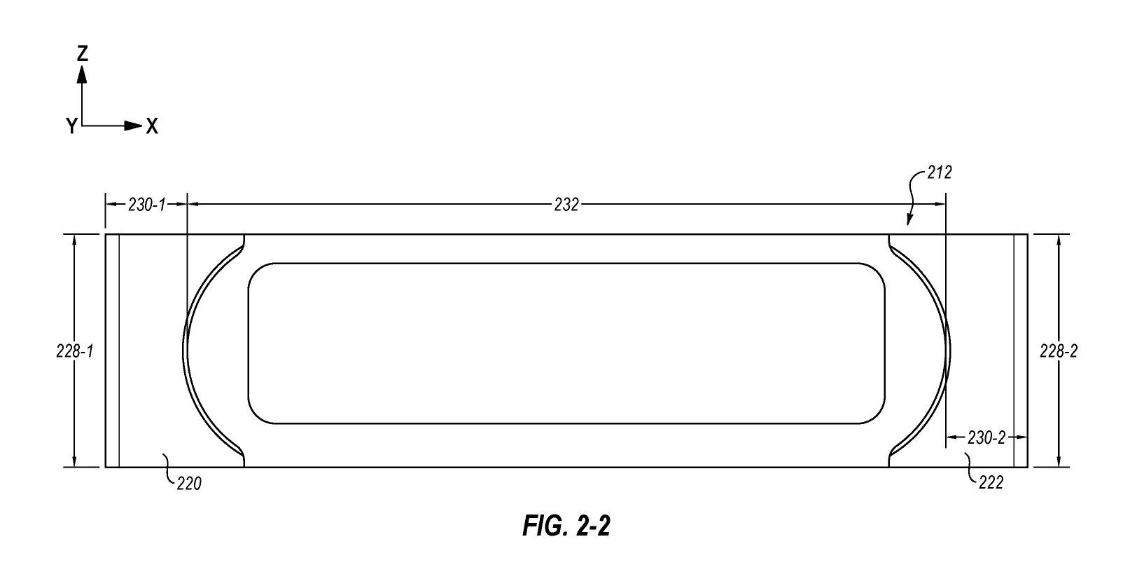

FIG. 1-2 illustrates an exploded view of the USB-C receptacle 110 illustrated in FIG. 1-1. The tongue assembly 150 may extend distally (e.g., toward the positive y-direction) at least partially through a tongue assembly opening 114 located at a proximal (e.g., toward the negative y-direction) portion 116 of the housing 112.

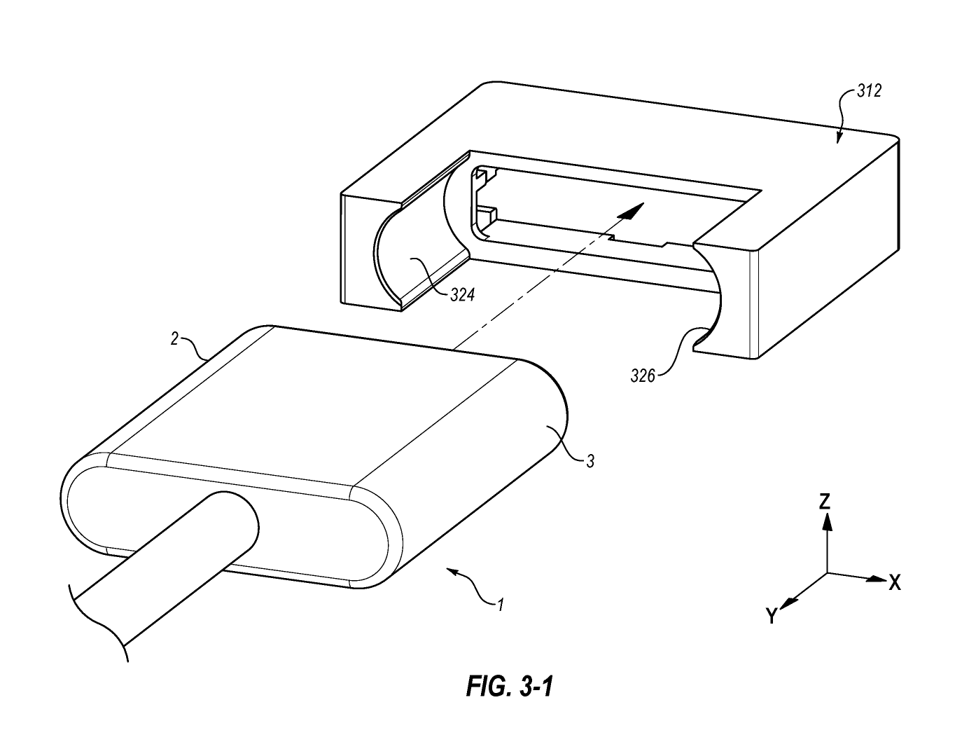

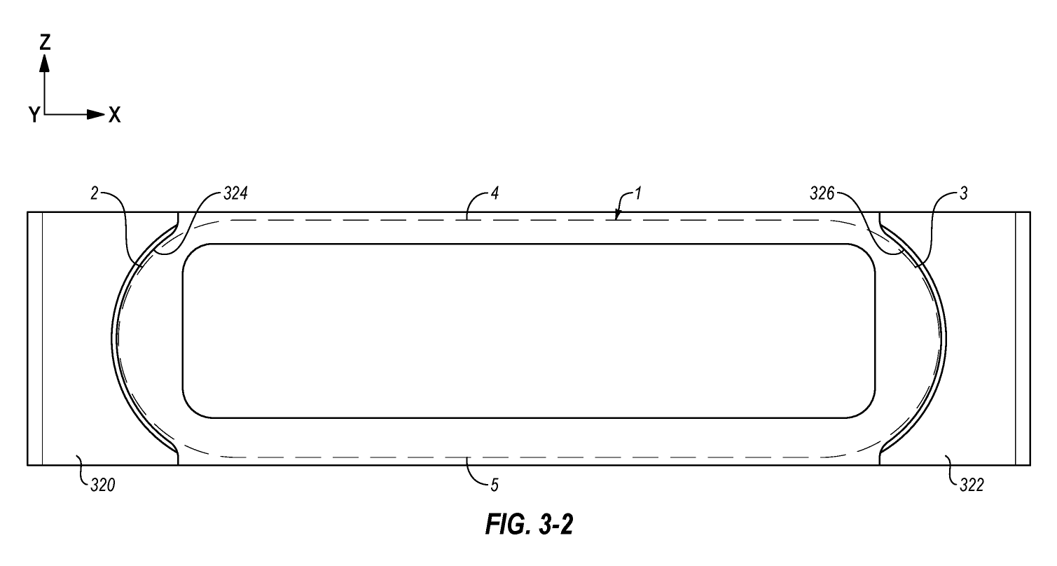

The tongue assembly 150 may be in electronic communication with a processor, memory, a circuit board, other components of a computing device (not shown), or combinations thereof at a proximal portion 116 of the USB-C receptacle 110. The USB-C receptacle 110, including the housing 112 and tongue assembly 150, may be configured to communicate and/or physically interface with a USB-C plug (shown in FIG. 3-1), the USB-C receptacle 110 receiving the plug (not shown) at a distal portion 118 of the USB-C receptacle 110. The USB-C receptacle 110 may be configured to be integrally connected or otherwise attached to a computing device chassis (not shown). Further illustrations and explanations of how the USB-C receptacle 110 may be integrated with a computing device and its various components will be given in reference to other figures described below.

The term “proximal” used herein is intended to denote a direction extending towards a computing device with which the USB-C receptacle 110 has been integrated. In other words, in the negative y-direction. Likewise, the term “distal” will herein be used to denote a direction extending away from a computing device with which the USB-C receptacle 110 has been integrated. In other words, in the positive y-direction.

FIG. 2-1 illustrates an embodiment of a housing 212. The illustrated embodiment of the housing 212 may include a tongue assembly opening 214 at a proximal portion 216 of the housing 212. The housing 212 may include a first housing sidewall 220 and a second housing sidewall 222 with corresponding first and second inner surfaces 224, 226. The illustrated housing 212, as well as other embodiments of housings herein described, may be made of stainless steel. Other suitable materials may include various plastic resins, various metal alloys, especially those amenable to the injection process, which allows for fine-feature creation. The housing 212 and other embodiments herein described may be manufactured using metal injection molding. Other manufacturing methods of the housing 212 may include CNC machining, additive manufacturing such as SLS or other related additive technologies.

FIG. 2-2 shows a front view of the housing 212 illustrated in FIG. 2-1. First and second housing sidewall heights 228-1, 228-2 are labeled to illustrate the heights of the first and second housing sidewalls 220, 222. First and second housing sidewall widths 230-1, 230-2 are labeled to illustrate the widths of the first and second housing sidewalls 220, 222. The housing sidewall widths 230-1, 230-2 are measured at the narrowest dimension of the first and second housing sidewalls 220, 222 in the x-direction. In the illustrated embodiment of FIG. 2-2, the heights 228-1, 228-2 of the first and second housing sidewalls 220, 222 are equal. This may not be the case in other embodiments. For example, in other embodiments, the height 228-1 of the first housing sidewall 220 may be greater or less than the height 228-2 of the second housing sidewall 222. The housing sidewall widths 230-1, 230-2 are also shown as being equal, but other embodiments may include first and second housing sidewalls 220, 222 with different widths 230-1, 230-2.

In the illustrated embodiment, the first and second housing sidewalls 220, 222 may have a maximum height 228-1, 228-2 of 2.85 mm. Other embodiments of a housing 212 may include housing sidewalls 220, 222 that are less than 2.85 mm. For example, in some embodiments, housing sidewalls 220, 222 may be between 2.72 mm and 2.85 mm. In another example, other embodiments may have housing sidewalls 220, 222 with heights 228-1, 228-2 between 2.64 mm and 2.72 mm. Other embodiments may include housing sidewalls 220, 222 with heights 228-1, 228-2 between 2.52 mm and 2.64 mm. Other embodiments may include housing sidewall heights 228-1, 228-2 of less than 2.52 mm. In this case the top and bottom sheet metal members would be shaped to maintain a continuous receptacle shell and remain in contact with the sidewalls in order to benefit from the structure provided by said sidewalls.

Current USB-C receptacles may not be able to achieve a total height of less than 2.86 mm. This may include that the standard plug height clearance requirement for a receptacle is 2.56 mm. Typically, sheet metal is used to wrap around into the shape of a receptacle. A practical range for sheet metal thickness is between 0.15 mm and 0.3 mm. Strength of the sheet metal is related to the thickness cubed. In some embodiments, it may not be desirable to manufacture sheet metal for this purpose at less than 0.2 mm due to decreased strength and durability. The typical receptacle includes sheet metal material on the top and bottom portions of the receptacle. Therefore, typical USB-C receptacles are limited to a minimum of 2.96 mm in height. Simply cutting away material from the top and/or bottom of a typical receptacle would fail to leave enough structural support to the receptacle to counteract torques that a plug may apply to the receptacle. The remaining sheet metal on either side of the plug would have a small cross-sectional moment of inertia that would likely be insufficient for properly securing a plug and resisting torques.

In the illustrated embodiment of FIG. 2-2, the housing sidewall widths 230-1, 230-2 are shown as being equal. Other embodiments may include housing sidewall widths 230-1, 230-2 that are not equal. FIG. 2-2 illustrates housing sidewalls 220, 222 with a width 230-1, 230-2 of 0.25 mm. Other embodiments may include housing sidewall widths 230-1, 230-2 of greater than 0.25 mm. For example, other embodiments may include housing sidewalls 220, 222 with widths 230-1, 230-2 between 0.25 mm and 0.5 mm. Also for example, housing sidewall widths 230-1, 230-2 may be greater than 0.5 mm. The greatest distance 232 between housing sidewalls 220, 222 may vary depending on the width of the plug 1 being received, or manufacturing tolerances capability, as illustrated in FIG. 3-1.

As shown in an embodiment illustrated in FIG. 3-1, a USB-C receptacle 312 may be configured to receive a plug 1 between the first and second housing sidewalls 320, 322. The first and second inner surfaces 324, 326 may be configured to make contact with first and second outer side surfaces 2, 3 of the plug 1 when the plug 1 is inserted into the USB-C receptacle 312. The first and second inner housing sidewall surfaces 324, 326 may be curvilinear surfaces configured to conform to the curvilinear first and second outer side surfaces 2, 3 of the plug 1. As such, the curvature of the first and second inner housing sidewall surfaces 324, 326 may vary depending on the curvature of the first and second outer side surfaces 2, 3 of the plug 1.

FIG. 3-2 illustrates a front view of the USB-C housing 312 and plug 1. The cross-section of the plug 1 is shown by the dotted line. It will be appreciated that the first and second housing sidewall inner surfaces 324, 326 may be configured to extend only partially around the first and second outer side surfaces 2, 3 of the plug 1, when the plug has been inserted into the housing 312 between the first and second housing sidewalls 220, 222. The housing 312 may be configured so as to not make contact with top and bottom outer surfaces 4, 5 of the plug 1. In some embodiments, the first and second housing sidewall inner surfaces 324, 326 may be configured to extend partially over top and bottom outer surfaces 4, 5 of the plug 1. In other embodiments, the first and second housing sidewall inner surfaces 324, 326 may be configured to extend completely over top and bottom outer surfaces 4, 5 of the plug 1. In yet other embodiments, the first and second housing sidewall inner surfaces 324, 326 may be configured to extend partially or completely over one or the other of the top and bottom outer surfaces 4, 5 of the plug 1.

The first and second housing sidewall inner surfaces 324, 326 may extend around the outer surfaces 2, 3, 4, 5 of the plug 1 so as to assist in securing and/or retaining the plug 1 within the housing 312 once it has been inserted. The housing may also provide stability and support to the plug 1 as it is wrenched or applies torques to the housing 312. Wrenching and torqueing may arise as the plug 1 is inserted and/or removed from the housing 312. Torques may also be applied by the plug 1 on the housing 312 when the plug 1 and/or a computing device to which the housing 312 may be secured is moved, jostled, otherwise disturbed, or combinations thereof.

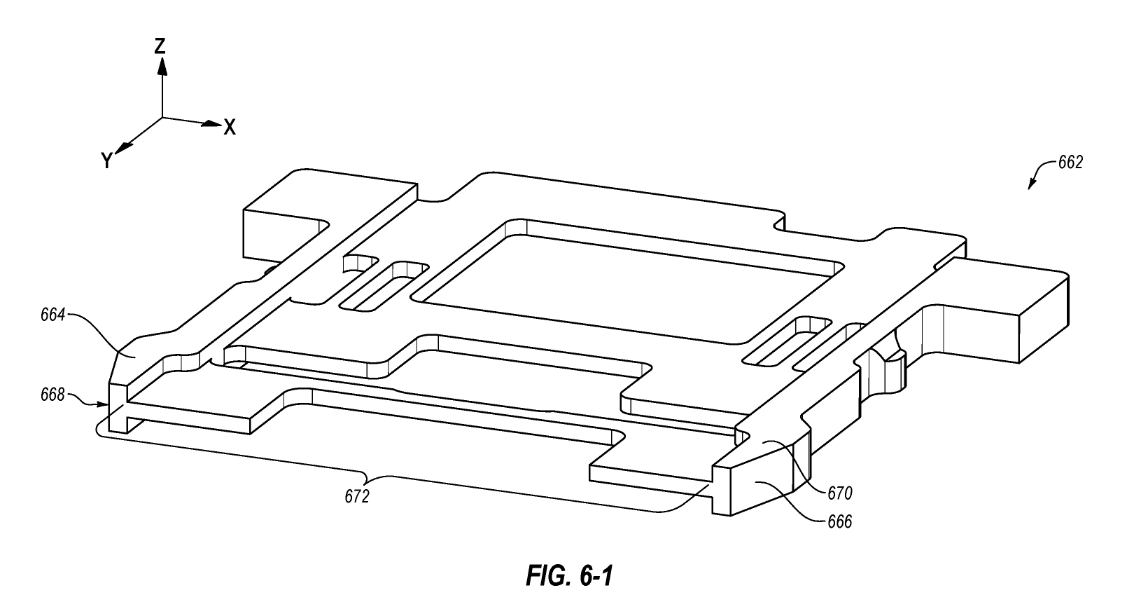

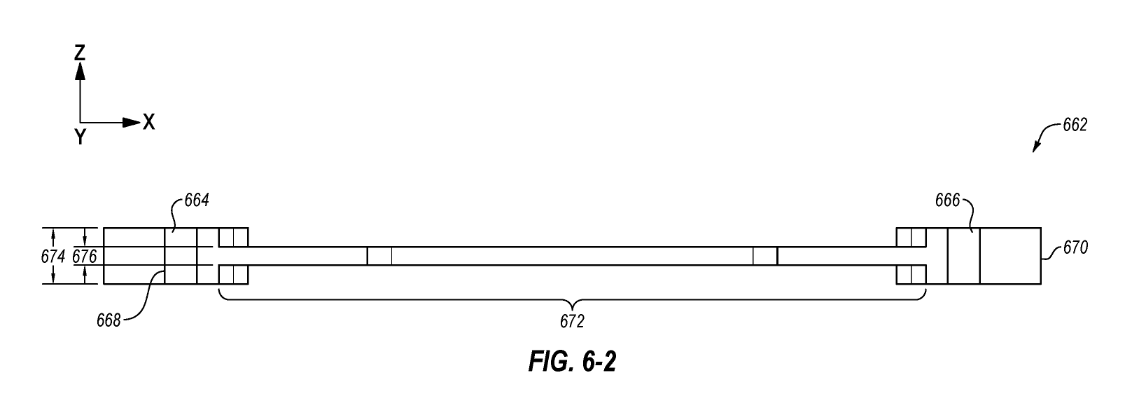

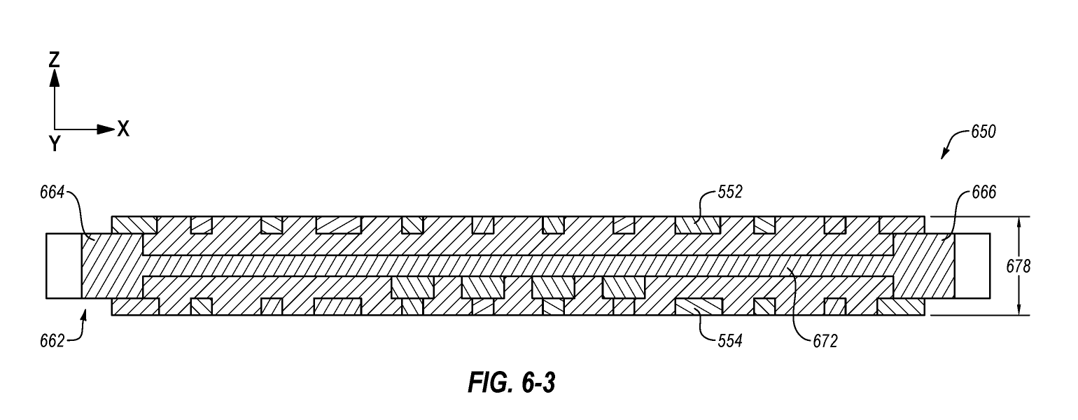

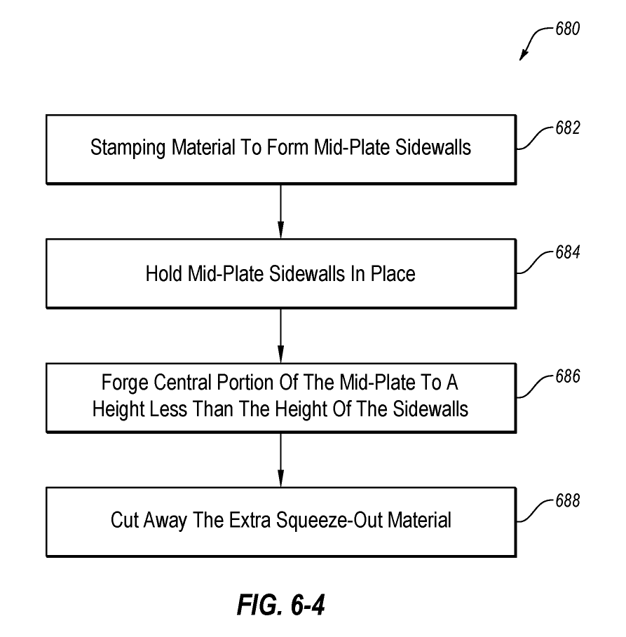

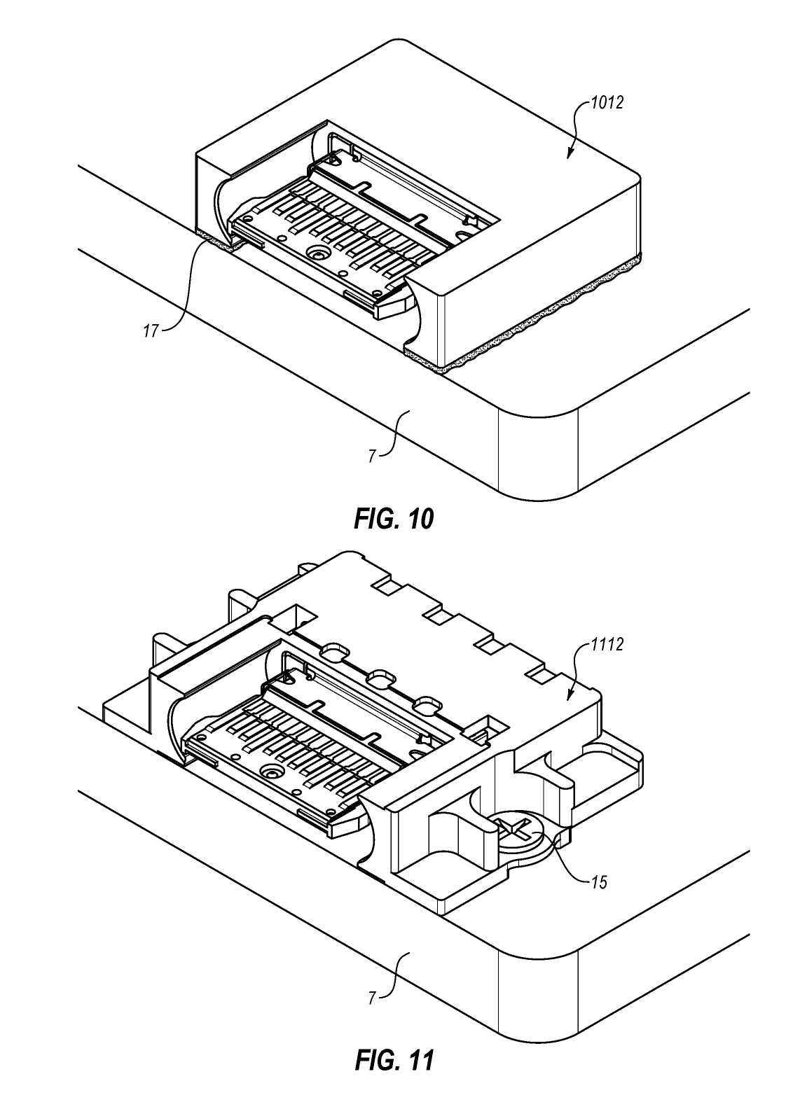

The housings 112, 212, 312 illustrated in FIGS. 1-1 through 3-2, and other embodiments of housings illustrated herein, may be configured to be attached directly to a chassis 7 of a computing device 6 as illustrated in FIGS. 10 through 12. In this way, the torques applied to the housing 412 by the plug 1 may be transferred directly to the chassis 7. This transfer of torques to the chassis 7 may protect other components of the USB-C receptacle 310 and/or computing device 6 from torques applied by a wrenching or jostling of the plug 1. These other components may include the USB-C receptacle tongue (illustrated in FIG. 6-1), circuit board (not shown) and/or other components of the computing device 6. An embodiment of a housing 412 attached to a chassis 7 is illustrated in in FIGS. 10 through 12 and described in further detail below. The typical USB-C receptacle currently used may not provide enough structural support to the plug and torques are therefore transferred to sensitive components such as the electrical contacts and/or circuit boards or other fragile components of a computing device 6.

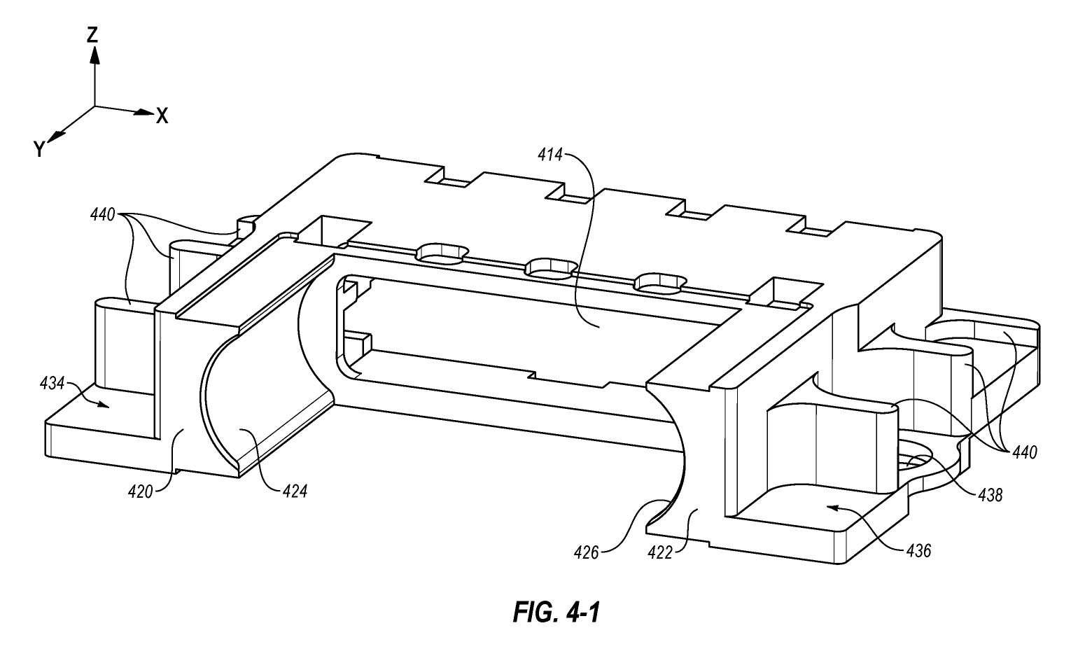

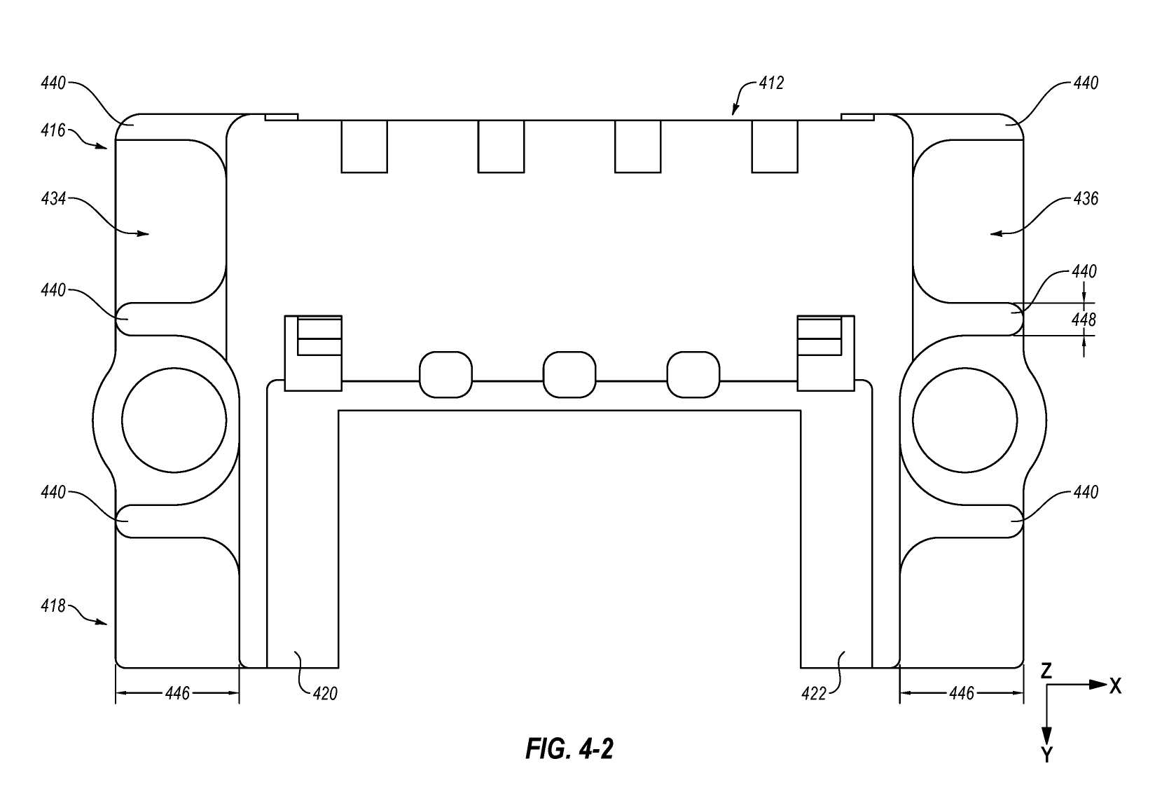

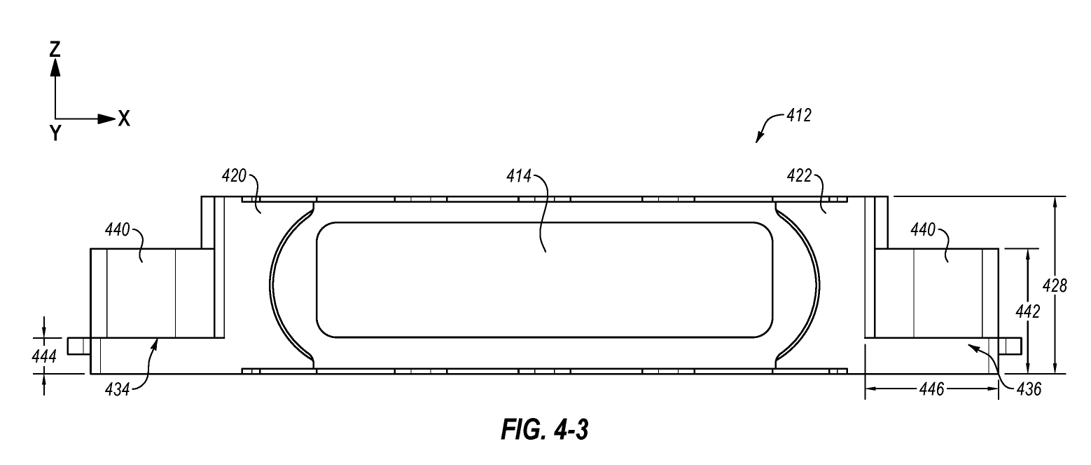

FIG. 4-1 illustrates an embodiment of a housing 412 that includes first and second housing sidewalls 420, 422 with corresponding first and second housing sidewall inner surfaces 424, 426, a tongue assembly opening 414 and first and second support members 434, 436. Support members 434, 436 may extend from the first and second housing sidewalls 420, 422 outwardly in the x-direction. Support members 434, 436 may be configured to provide structural support to the first and second housing sidewalls 420, 422. Support members 434, 436 may also be configured to provide extra material to be utilized in attaching the housing to a chassis 7 of a computing device 6. In the illustrated embodiment, support members 434, 436 extend form both the first and second housing sidewalls 420, 422. In other embodiments, only one or the other of the first and second housing sidewalls 420, 422 may have support members 434, 436 extending therefrom.

The illustrated embodiment of a housing 412 may include support members 434, 436, each of which may include an aperture 438. The aperture 438 may be configured to receive a bolt, screw, or other fastening mechanism in order to attach the housing 412 to a computing device 6 chassis 7 (not shown). Attachment of the housing 412 to a chassis 7 will be illustrated and explained in further detail below. Support members 434, 436 may include more or less than one aperture 438. For example, support members 434, 436 may include no apertures 438, two apertures 438, or more than two apertures 438. Also, one of the support members 434, 436 may include one or more apertures 438, while the other support member 434, 436 may include none. For example, the second support member 436 may include one or more apertures 438 present while the first support member 434 may include none. Also for example, first and second support members 434, 436 may include different numbers of apertures 438.

The support members 434, 436 illustrated in FIG. 4-1 may also include one or more vertical features 440. The vertical features 440 may be located anywhere along the support members 434, 436. There may be one or more vertical features 440 on one or the other support members 434, 436. The vertical features 440 may provide added structural support to the support members 434, 436 and/or the first and second housing sidewalls 420, 422.

The vertical features 440 may increase a cross-sectional moment of inertia of the support members 434, 436, and therefore of the entire housing 412, in the x-z plane. A greater cross-sectional moment of inertia may resist torques applied by the plug 1 to a greater degree, further protecting sensitive components from damage. Such sensitive components may include the tongue 150 or other computing device 6 components such as a circuit board (not shown) from torques applied by the plug 1. The cross sectional moment of inertia of the housing 412 may be more than 1.9 mm⁴, may be between 1.9 mm⁴ and 7 mm⁴, or may be more than 7 mm⁴.

FIGS. 4-2 and 4-3 illustrate a top view and a front view, respectively, of the housing 412 illustrated in FIG. 4-1. In the illustrated embodiment shown in FIG. 4-2, the support members 434, 436 extend along the entire first and second housing sidewalls 420, 422 in the y-direction from a distal portion 418 of the housing 412 to a proximal portion 416 of the housing 412. In other embodiments, support members 434, 436 may extend only partway along the first and/or second sidewalls 420, 422 in the y-direction. Alternatively, in other embodiments, one or more support members 434, 436 may extend partially along one of the first or second housing sidewalls 420, 422 and entirely along the other. It will be appreciated from the foregoing description of the support members 434, 436 that any number of combinations of support members 424, 426 extending along one or the other first and second housing sidewalls 420, 422, either partially or entirely, may be achieved.

FIG. 4-3 illustrates a front view of the housing 412 including support members 434, 436. The height 442 of vertical features 440 of the support members 434, 436 of the illustrated embodiment may be less than or equal to the height 248 of the housing sidewalls 420, 422. Other embodiments may include vertical features 440 that may be taller or shorter than the height 442 illustrated. Other embodiments may include one or more of the vertical features 440 that may vary in height 442. The thickness 448 of one or more of the vertical features 440, as illustrated in FIG. 4-2, may vary. The shape of the vertical features 440, either as seen from the top view in FIG. 4-2 or the front view in FIG. 4-3, may be any shape. For example, the vertical features may be rounded, square, polygonal, or otherwise curvilinear in shape.

A minimum height 444 of the one or more support members 434, 436 may be 0.25 mm. A minimum width 446 of the one or more support members 434, 436 may be 0.65 mm. Other embodiments may include one or more support members 434, 436 with widths 446 between 0.65 mm and 0.9 mm and heights 444 between 0.25 and 1.5 mm. Yet other embodiments may include one or more support members 434, 436 with widths 446 greater than 0.9 mm and heights 444 between 1.5 mm and 2.85 mm.

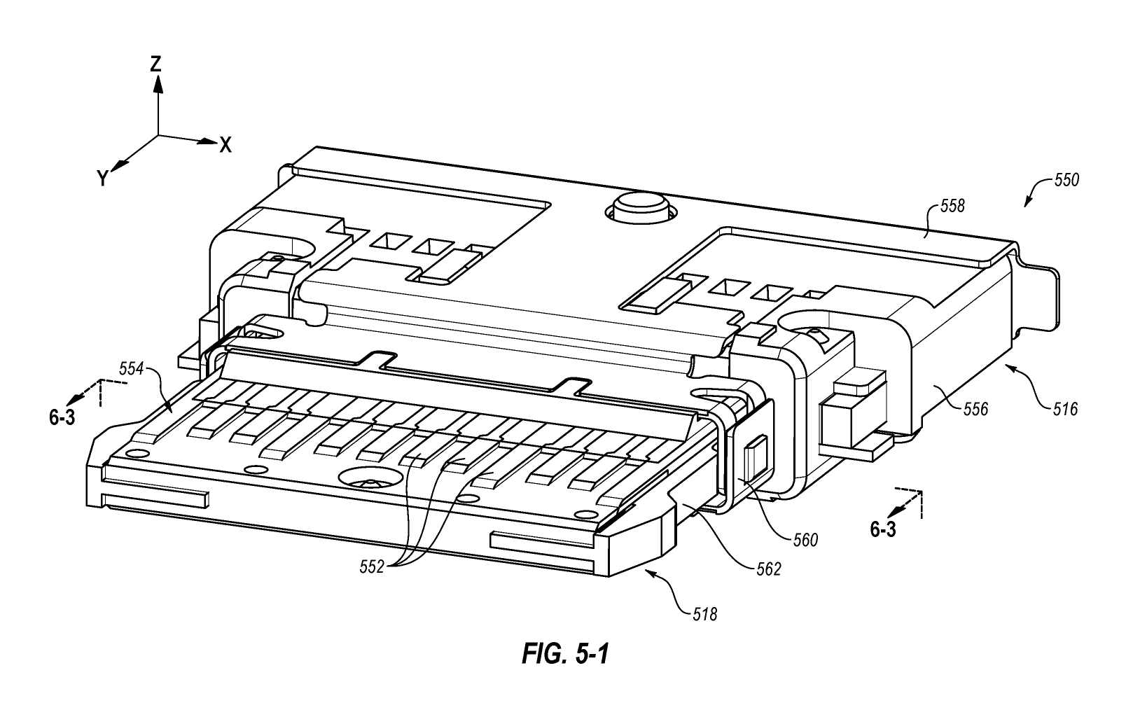

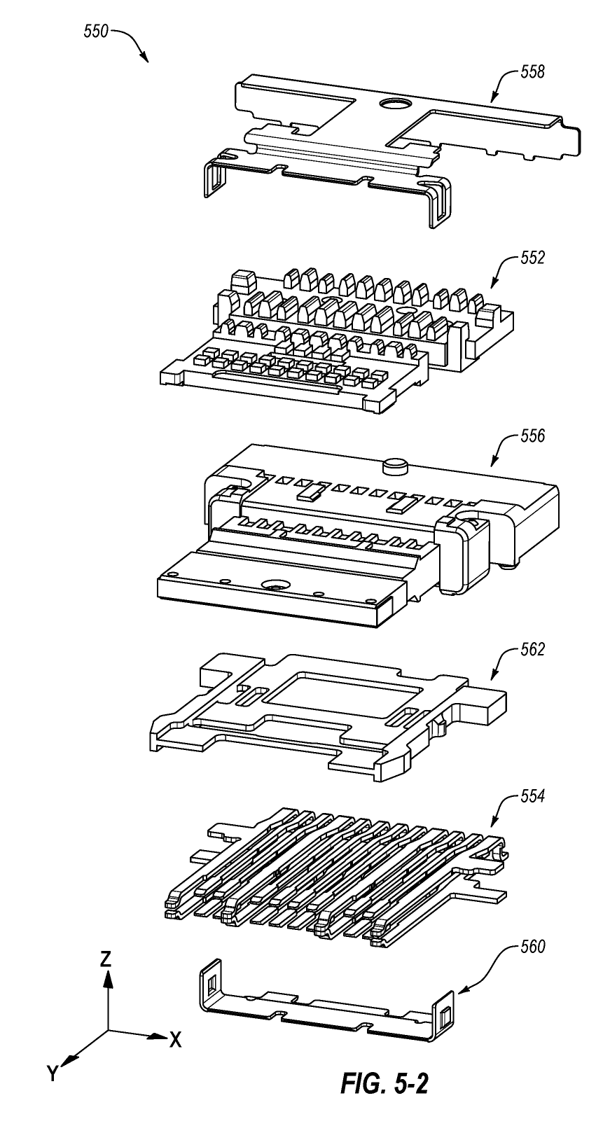

The various embodiments of the housing 112, 212, 312, 412 described herein may be configured to provide a space between the first and second housing sidewalls 420, 422 in which a plug 1 may interface with various electrical contacts 552 located on a tongue assembly 550. FIG. 5-1 illustrates a tongue assembly 550. FIG. 1-2 illustrates an exploded view of the USB-C receptacle 110 illustrated in FIG. 1-1. The tongue assembly 150, 550 may extend distally at least partially through a tongue assembly opening 114 located at a proximal portion 116 of a housing 112.

The tongue assembly 150 may be configured to communicate with a circuit board and/or other component of a computing device (not shown) at a proximal portion 116 of the USB-C receptacle 110. The USB-C receptacle 110, including the housing 112 and tongue assembly 150, may be configured to communicate and/or physically interface with a plug (not shown), the USB-C receptacle 110 receiving the plug (not shown) at a distal portion 118 of the USB-C receptacle 110.

FIG. 5-1 illustrates an embodiment of a tongue assembly 550. FIG. 5-2 illustrates an exploded view of the embodiment illustrated in FIG. 5-1. The tongue assembly may include a core 556, top and bottom electrical contacts 552, 554, a top and bottom collar 558, 560, and a mid-plate 562. The bottom collar 558, 560 may be used as a shielding portion and are shown as being distinct. In other embodiments, the bottom collar 558, 560 may be one continuous part. The top and bottom collars 558, 560 may be welded at a proximal portion 516 of the mid-plate 562, as illustrated in FIG. 5-1. The mid-plate 562 in FIG. 5-2 may provide a barrier between top and bottom electrical contacts 552. The mid-plate 562 may also provide an electrical ground contact to the signal contacts which are also ground contacts, such as component 554 in FIG. 5-1.

An embodiment of a mid-plate 662 is illustrated in FIG. 6-1. The mid-plate includes first and second mid-plate sidewalls 664, 666, with corresponding mid-plate sidewall outer surfaces 668, 670 and a central portion 672. The first and second mid-plate sidewall outer surfaces 668, 670 may be curvilinear to conform to and/or receive a retention latch of a plug 1 being received by the USB-C receptacle (not shown). More detail regarding the plug retention latch and its interaction with the mid-plate sidewalls 664, 666 will be given hereafter.

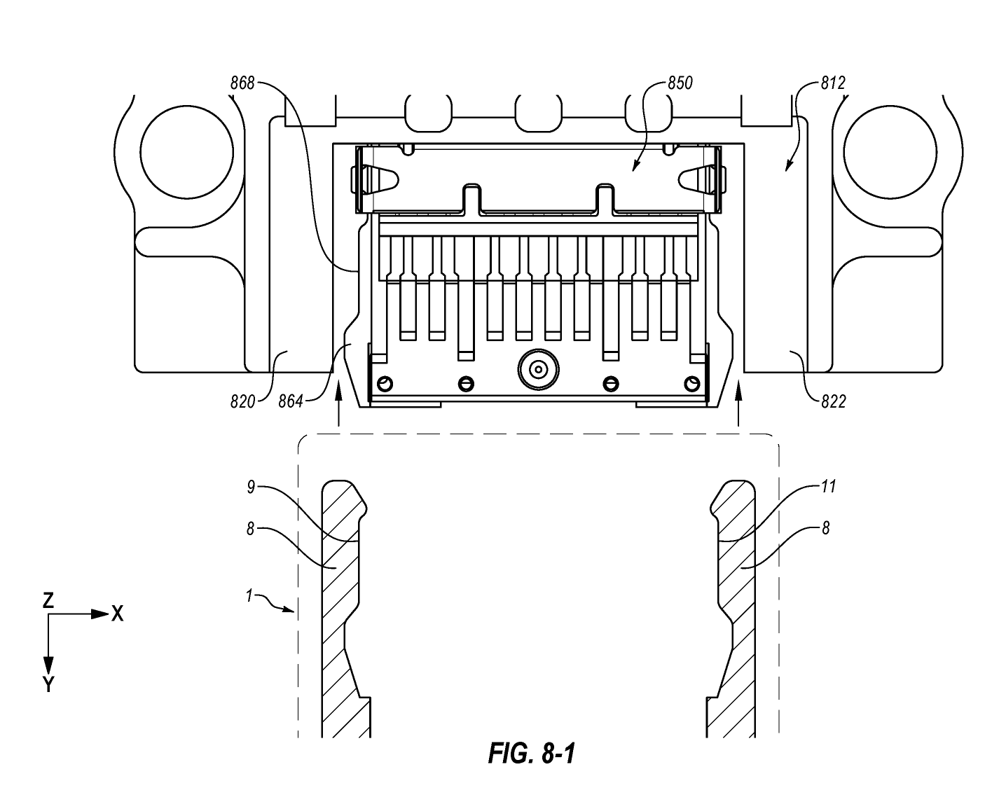

A front view of the embodiment of the mid-plate 662 is illustrated in FIG. 6-2. As shown, the first and second mid-plate sidewalls 664, 666 may have a height 674 greater than the height 676 of the central portion 672. The mid-plate sidewalls 664, 666 may be configured to make contact with and/or receive a plug retention latch (not shown). The interface between the plug retention latch and the mid-plate sidewalls 664, 666 will be described in reference to FIGS. 8-1 and 8-2 below. The height of the mid-plate sidewalls 664, 666 may be between 0.2 and 0.6 mm. A mid-plate sidewall height 674 between 0.2 mm and 0.6 mm may ensure that proper contact and/or alignment with a plug retention latch is made when a plug 1 is inserted into a USB-C receptacle 110. Typical plug retention latches currently used have heights between 0.2 mm and 0.40 mm. In other embodiments of a mid-plate 662, the mid-plate sidewall height may be greater than 0.6 mm.

The height 676 of the central portion 672 may be greater than 0.05 mm but less than 0.175 mm. A cross-sectional view of a tongue assembly 662 including the embodiment of the mid-plate 662 illustrated in FIGS. 6-1 and 6-2 is illustrated in FIG. 6-3. The height 676 of the central portion 672 may be greater than 0.05 mm in order to provide a sufficiently large electrical barrier between upper and lower electrical contacts 552, 554. The height 676 of the central portion 672 may be less than 0.175 mm in order to maintain the signal integrity of the electrical contacts 552, 554. If the height 676 of the central portion 672 is greater than 0.175 mm, the mid-plate 662 may be too close to the electrical contacts 552, 554, resulting in a decrease in impedance. A decrease in impedance may result in a poor signal integrity.

Therefore, in the present embodiment, the mid-plate 662 provides a thin but sufficient barrier and ground contact between the electrical contacts 552, 554 at the central portion 672. The thin central portion 672 allows for a thin stacking height 678, which is the total height of the tongue assembly 650. At the same time, the mid-plate sidewalls 664, 666 protect the tongue assembly 650 from damaging wear due to contact with a plug retention latch (not shown) as the plug 1 is repeatedly inserted and extracted from a housing 312 (see FIG. 3). The mid-plate 662 provides this barrier, ground contact, and tongue assembly 650 protection in a single piece of material.

Typical mid-plate designs may include a piece of sheet metal or other material placed between the electrical contacts 552, 554 with a uniform height. This uniform height may be less than 0.175 mm in order to maintain the signal integrity of the electrical contacts 552, 554. The height of the outer edges of a typical mid-plate are therefore insufficient to ensure proper contact and/or alignment between the mid-plate and a plug retention latch. This may result in damage to the electrical contacts of a typical UBC-C receptacle.

The mid-plate 662 may be manufactured from a single piece of material, which simplifies and reduces the cost of manufacturing. FIG. 6-4 describes the manufacturing process 680. A single piece of material may be stamped at a desired height and shape of the mid-plate sidewalls 682. The first and second sidewalls 664, 666 may then be held in place 684 while the central portion 672 is forged to a height 676 less than the height 674 of the first and second mid-plate sidewalls 686. The extra squeeze-out material may then be cut away 688.

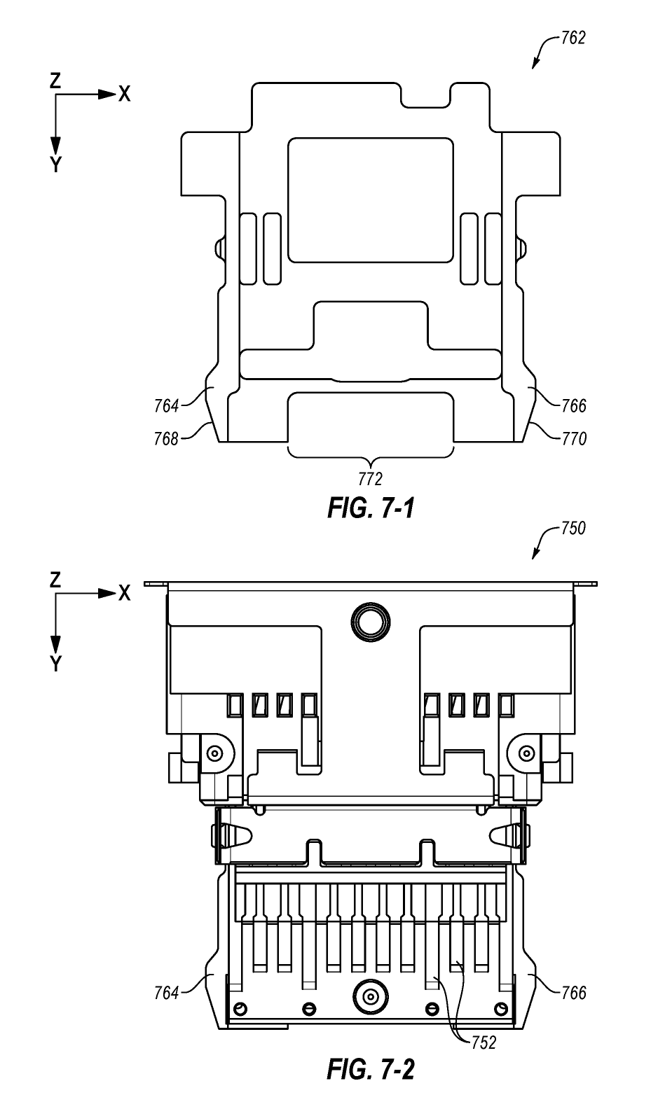

FIGS. 7-1 through 8-2 illustrate how an embodiment of a mid-plate 762 protects other components of a tongue assembly 750, such as the electrical contacts 752. The mid-plate sidewalls 764, 770 may extend laterally in the x-direction beyond any other component of the tongue assembly 750. As illustrated in FIG. 7-2, the mid-plate sidewalls 764, 766 may also extend distally beyond other components of the tongue assembly 750 in the y-direction. This may ensure that the retention latch of a plug (not shown) does not make contact with any other component of the tongue assembly 750 when the plug 1 is inserted into the housing 812, making contact between the plug electrical contacts (not shown) and the electrical contacts 752 of the tongue assembly 750. The outer contours of the mid-plate 762, as seen from the top view illustrated in FIG. 7-1, may vary depending on the size and shape of the tongue assembly 750 and the contours of the plug retention latch 8 (shown in FIGS. 8-1 and 8-2).

The sides of the midplate in a traditional, single thickness stamping, (not shown) may be particularly vulnerable to wear due to insertion and extraction of the plug 1. Smaller surface area (due to a typical 0.15 mm thickness) leads to faster wear and reduced performance typically follows. The mid-plate sidewalls 764, 766, as shown in FIG. 7-2, may be made of more robust material than the electrical contacts 752 and can therefore withstand repeated contact with the plug retention latch 8 illustrated in FIGS. 8-1 and 8-2. For example, the mid-plate sidewalls 764, 766 may be made of steels such as stainless and plated steels. The electrical contact materials may include steel, hardened copper alloy, or other suitable metals.

FIGS. 8-1 and 8-2 illustrate how a plug 1 may be secured to a tongue assembly 850 when inserted into a housing 812. The plug 1 is illustrated in dotted lines except for the retention latch 8 that resides within the plug 1. As shown, first and second mid-plate sidewall outer surfaces 868, 870 may be configured to compliment the curvature of first and second retention latch inner surfaces 9, 11. As the plug 1 is inserted over the tongue assembly 850, these surfaces make contact and create a mating interface 13 that may resist the retraction of the plug 1. The retention latch 8 may only make contact with the first and second mid-plate sidewalls 864, 866. The mating interface 13 between the plug 1 and the tongue assembly 850 may also serve to align the plug 1 with the tongue assembly 850 in order to ensure proper communication between the plug 1 and the electrical contacts 852 of the tongue assembly 850. Maintaining a consistent ground contact between 8 and 864 over life is important to maintaining performance of the connection over life, both mechanically and electrically.

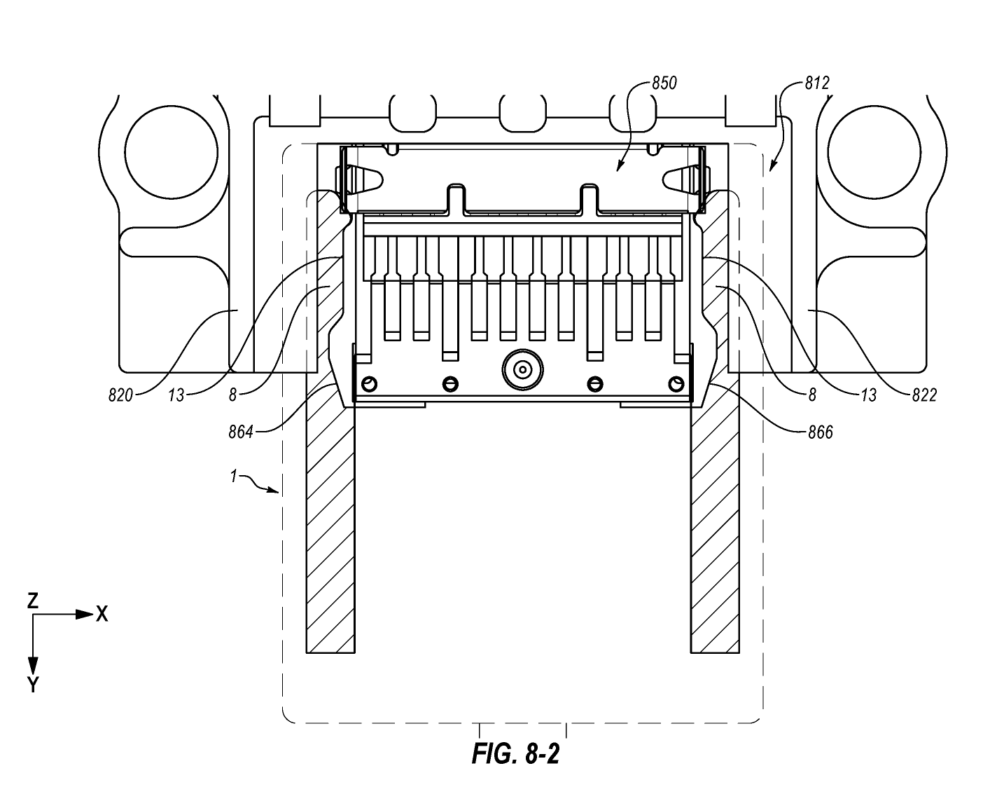

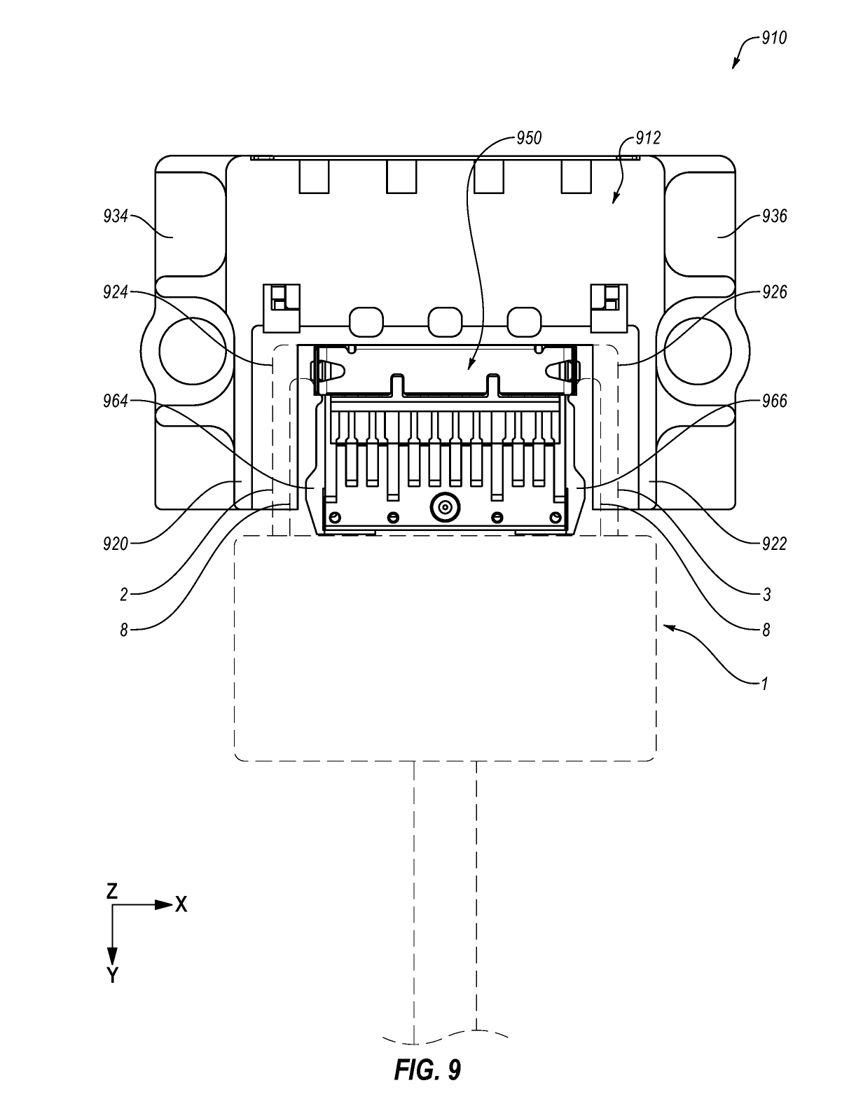

FIG. 9 illustrates a top view of a USB-C receptacle 910 with a plug 1 (illustrated in dotted lines) inserted between first and second housing sidewalls 920, 922 of a housing 912 that includes first and second support members 934, 936. The plug 1 may be inserted into the USB-C receptacle 910 so that first and second outer side surfaces 2, 3 of the plug 1 may make contact with first and second housing sidewall inner surfaces 924, 926. A plug retention latch 8 may interface with first and second mid-plate sidewalls 964, 966 extending laterally in the x-direction from the tongue assembly 950. In the illustrated embodiment, the mid-plate sidewalls 964, 966 may ensure a proper alignment of the plug 1 via the plug retention latch 8 and protect other components of the tongue assembly 950 from damage and/or wear.

In addition, the first and second housing sidewalls 920, 922 and corresponding housing sidewall inner surfaces 924, 926 may interface with first and second outer side surfaces 2, 3 of the plug 1 in order to secure the plug 1 within the USB-C receptacle 910. The housing 912 may be attached directly to a chassis 7 of a computing device 6 in order to transfer torques applied from the plug to the chassis 7. This may prevent torques from the plug 1 from being transferred to the tongue assembly 950 and/or other computing device components such as a circuit board (not shown) to which the tongue assembly 950 may be connected.

The interaction of the mid-plate sidewalls 964, 966 and housing sidewalls 920, 922 with the plug 1 may ensure consistent electrical contact between the USB-C receptacle 910 and the plug 1. It may also provide a consistent cable experience for the user when inserting and extracting the plug 1 from the USB-C receptacle 910 across various plug designs and manufacturing variations.

FIGS. 10 and 11 illustrate embodiments of a housing 1012, 1112 attached directly to a chassis 7. A housing 1012 may be attached directly to a chassis 7 of a computing device. For example, the housing 1012 may be adhered to the chassis 7 using glue, epoxy, or other adhesive compositions 17. Also for example, the housing 1012 may be screwed 15, bolted, and/or press-fit onto the chassis 7. It will be appreciated that the housing 1012, 1112 may be attached to the chassis 7 in any way that results in the housing 1012, 1112 being rigidly secured to the chassis 7 in order to transfer torques applied to the housing 1012, 1112 to the chassis 7 of a computing device 6.

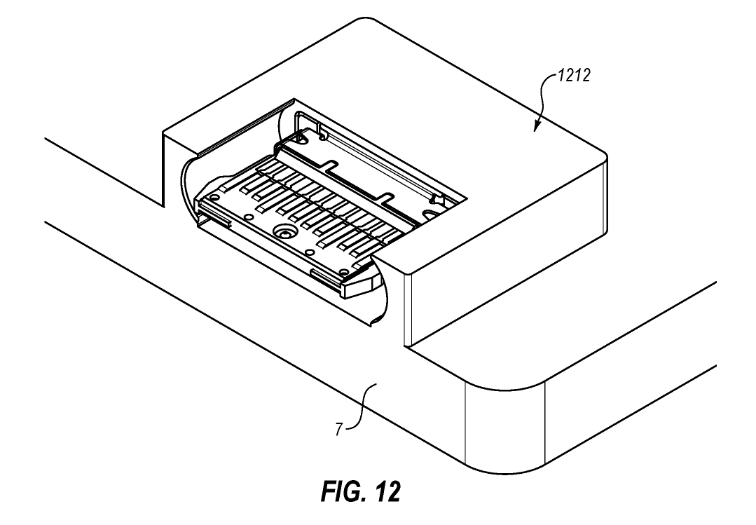

The housing 1212 may be integrally attached to the chassis 7. For example, the housing 1212 may be formed with the chassis 7 from a single piece of material. FIG. 12 illustrates a housing 1212 integrally formed with a chassis 7 from a single piece of material. It may be advantageous to integrally attach and/or form the housing 1212 with the chassis 7 to simplify manufacturing and reduce costs. Being integrally attached also ensures a firm connection between the housing 1212 and chassis 7 for transferring torques to the chassis 7 and discussed above.

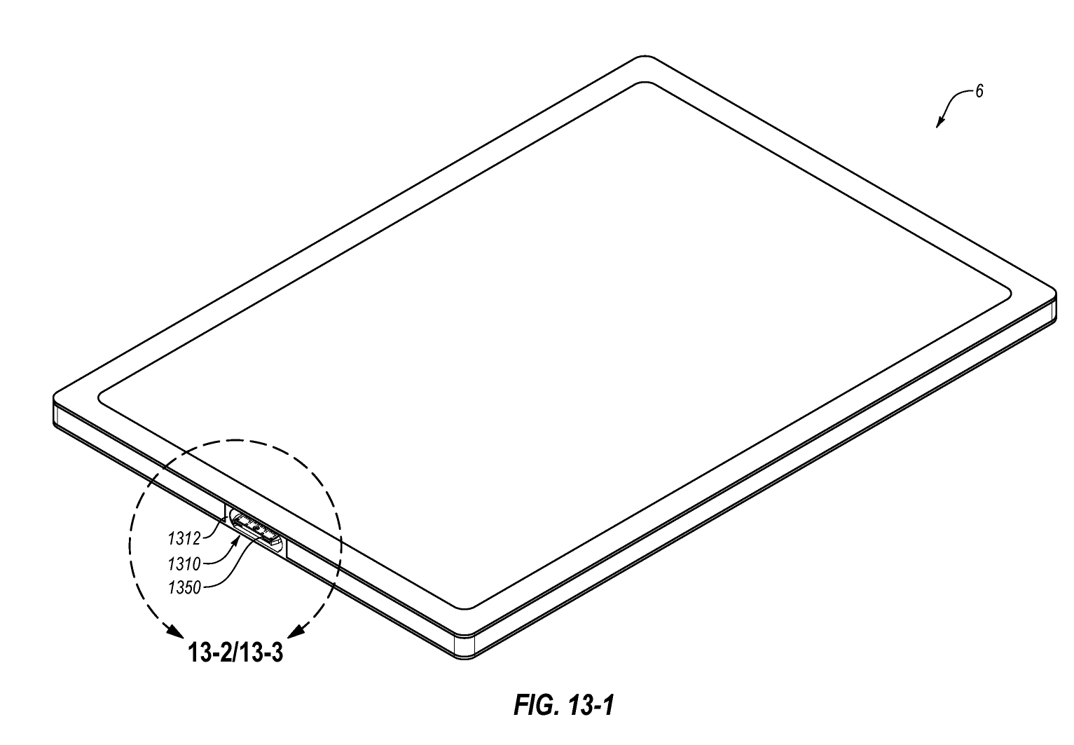

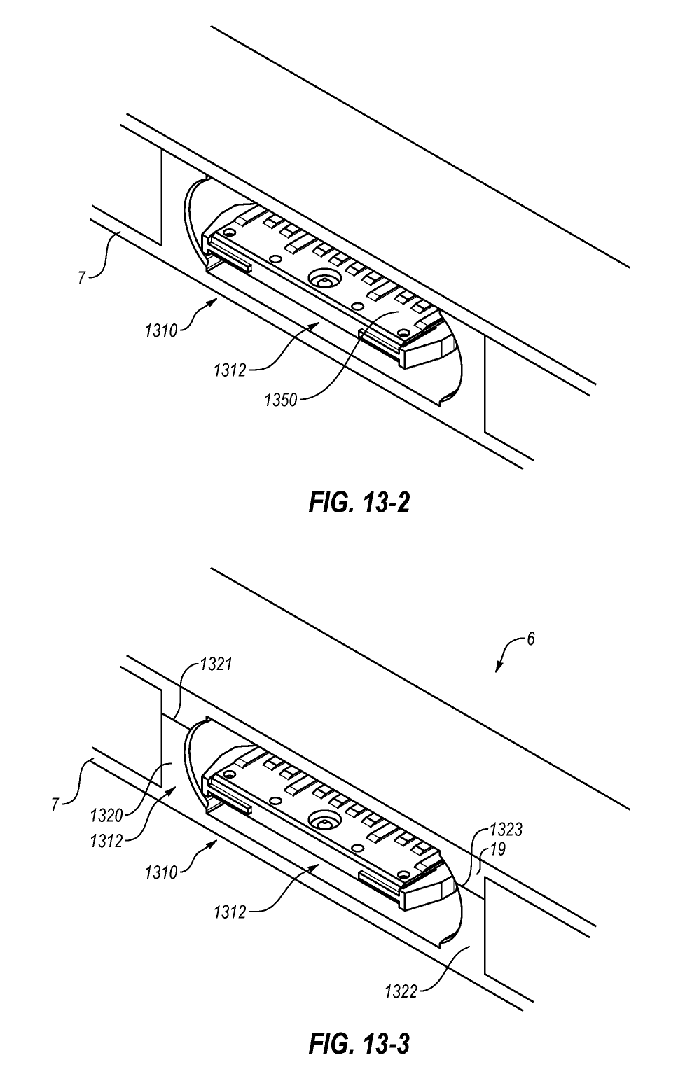

FIGS. 13-1 through 13-3 illustrate an embodiment of a USB-C receptacle 1310 housing 1312 that has been secured in a computing device 6. In the illustrated embodiment, the USB-C receptacle 1310 may be accessed from a side edge of the computing device 6. In other embodiments, the USB-C receptacle 1310 may be located elsewhere on the computing device 6. FIG. 13-2 illustrates a close up view of the computing device 6 shown in FIG. 13-1. The USB-C receptacle 1310 may provide a sleek, uniform appearance with the surface of the computing device 6 in which it may be attached.

As illustrated in FIG. 13-3, some embodiments of a USB-C receptacle 1310 may be secured within a computing device 6 so that the device bezel 19 makes contact with the housing 1312 at a top portion of the first and second housing sidewalls 1321, 1323. In this configuration, the bezel 19 may add structural support to the housing 1312 and allow for first and second housing sidewalls 1320, 1322 to structurally interface, while maintaining enough clearance for a plug 1 to be inserted therein.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

It should be understood that any directions or reference frames in the preceding description are merely relative directions or movements. For example, any references to “front” and “back” or “top” and “bottom” or “left” and “right” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

1. A USB-C receptacle housing, comprising:
a first housing sidewall configured to be attached to a chassis of a computing device; and
a second housing sidewall configured to be attached to the chassis of the computing device,
wherein the first and second housing sidewalls have a height equal to or less than about 2.85 mm.

2. The USB-C receptacle housing recited in claim 1, wherein first and second inner surfaces of the first and second housing sidewalls are configured to extend only partially around first and second outer side surfaces of a USB-C plug received by the receptacle housing.

3. The USB-C receptacle housing recited in claim 1, wherein the first and second housing sidewalls are configured to provide resistance to torques applied to the receptacle housing by the USB-C plug.

4. The USB-C receptacle housing recited in claim 1, wherein the first and second housing sidewalls are integrally attached to the chassis.

5. The USB-C receptacle housing recited in claim 1, wherein the first and second housing sidewalls have a minimum width of about 0.25 mm.

6. The USB-C receptacle housing recited in claim 1, wherein a maximum height of the first and second housing sidewalls is about 2.72 mm.

7. The USB-C receptacle housing recited in claim 1, wherein the cross-sectional moment of inertia of the USB-C receptacle housing is at least about 1.9 mm⁴.

8. A system for receiving a USB-C plug, the system comprising:
the USB-C receptacle housing of claim 1;
a USB-C receptacle tongue having a mid-plate
including:
a central portion; and
first and second mid-plate sidewalls configured to receive a plug retention latch,
wherein a height of the first and second mid-plate sidewalls is greater than a height of the central portion of the mid-plate.

9. The USB-C receptacle tongue recited in claim 8, wherein the first and second mid-plate sidewalls comprise first and second outer surfaces, wherein the first and second outer surfaces are the outermost surfaces of the receptacle tongue in the x-direction.

10. The USB-C receptacle tongue recited in claim 9, wherein the first and second outer surfaces of the first and second mid-plate sidewalls are configured to make contact with the plug retention latch.

11. The USB-C receptacle tongue recited in claim 8, wherein the height of the central portion of the mid-plate is between about 0.05 mm to 0.175 mm.

12. The USB-C receptacle tongue recited in claim 8, wherein the height of the first and second mid-plate sidewalls is between about 0.2 mm and 0.6 mm.

13. The USB-C receptacle tongue recited in claim 8, further comprising a top collar and a bottom collar.

14. The USB-C receptacle tongue recited in claim 8, wherein the mid-plate is a single piece.

15. A system for receiving a USB-C plug, the system comprising:
a receptacle housing, wherein the receptacle housing comprises:
a first housing sidewall configured to be attached to a chassis of a computing device; and
a second housing sidewall configured to be attached to the chassis of the computing device,
wherein the first and second housing sidewalls have a height equal to or less than about 2.85 mm; and
a receptacle tongue comprising a mid-plate, wherein the mid-plate comprises:
a central portion; and
first and second mid-plate sidewalls configured to receive a plug retention latch, wherein a height of the first and second mid-plate sidewalls is greater than a height of the central portion of the mid-plate.

16. The system recited in claim 15, wherein a maximum height of the first and second housing sidewalls is about 2.52 mm.

17. The system recited in claim 16, further comprising a bezel of the computing device, wherein the first and second housing sidewalls make contact with the bezel of the computing device on a top portion of the first and second sidewalls.

18. The system recited in claim 15, wherein the first housing sidewall is attached to the chassis of the computing device via a first supporting member, and wherein the second housing sidewall is attached to the chassis of the computing device via a second supporting member.

19. The system recited in claim 18, wherein the first support member is integral to the first housing sidewall, and wherein the second support member is integral to the second housing sidewall.

20. The system recited in claim 15, wherein the receptacle housing is integrally attached to the chassis of the computing device.
